(19) United States
(12) Patent Application Publication
(10) Pub. No.: US 2013/0019784 A1
(43) Pub. Date: Jan. 24, 2013

(54) Alert system with security mode for electronic safe

(71) Applicant: Johnson Yang, La Verne, CA (US)

(72) Inventor: Johnson Yang, La Verne, CA (US)

(21) Appl. No.: 13/136,047

(22) Filed: Jul. 20, 2011

(51) Int. Cl. E05G 1/04; G06F 7/00; E05B 49/00

(52) U.S. Cl. 109/59 R; 70/278.1; 340/5.7

(57) ABSTRACT

An electronic safe includes a security housing, a latching device and a security control system. The security housing has a housing body and a housing door movably connected to the housing body to form a receiving cavity within the security housing. The security control system is provided on the security housing, and includes a control unit provided on the security housing, and is arranged to be operated between a normal mode and a security mode, wherein in the normal mode, a user is able to operate the latching device through the control unit which is arranged to generate a predetermined interactive signal in response to the user's control, wherein in the security mode, the user is able to operate the latching device through the control unit which is arranged to not generate any interactive signal in response to the user's control.

### BACKGROUND OF THE PRESENT INVENTION

1. Field of Invention

The present invention relates to a safe, and more particularly to an electronic safe comprising a security control system which enables a user to selectively open or close the electronic safe without any audible sound or other interactive signals.

2. Description of Related Arts

A conventional electronic safe typically comprises a safe housing comprising a housing body and a housing door, a latching arrangement provided on the safe housing for selectively locking the housing door to the housing body, and a control unit usually provided on the housing door for controlling an operation of the latching arrangement. Conventionally, when the user wishes to open the safe (i.e. unlock the housing door from the housing body), he or she needs to control the control unit in a predetermined manner so as to actuate the latching arrangement to unlock the housing door. As a matter of conventional art, the control unit usually comprises a central processing unit electrically connected to the latching arrangement, and an input device (such as a key pad) electrically connected to the central processing unit in such a manner that a user is able to input predetermined control commands to the input device to the central processing unit, which is then arranged to control the latching arrangement for locking or unlocking the housing door.

As an example, the input device may comprise a key pad having a plurality of buttons and the latching arrangement can only be unlocked by typing in a predetermined combination through the key pad. Alternatively, the input device can comprise many other devices which are adapted for collecting user's biometrics. For instances, the input device can comprise a fingerprint sensor for scanning a user's fingerprint. When the user's fingerprint matches with an authorized fingerprint, the control unit is arranged to unlock the latching arrangement.

A common feature of the above-mentioned conventional electronic safes is that the control unit is arranged to deliver predetermined audible sound when it is being operated. For example, when the user types on a key pad as the input device, the key pad will generate a “beep” sound for each numeral typed. Moreover, when a correct combination is entered, the control unit will generate predetermined audible sound for signaling opening of the housing door.

Apart from audible sound, yet there exist other electronic safes in which the control unit is arranged to generate something which visually alerts the users of their inputs. For example, the control unit may further comprise a display unit in which the user's combination may be displayed on the display unit.

There are several disadvantages in association with the above-mentioned electronic safe. First, the generation of the audible sound may give a potential intruder the location of the person opening the safe. This is because when the user is operating the safe, the audible sound may draw attention to other people. This presents potentially serious security issue. Furthermore, when inputs are displayed on the display unit, persons other than the user may observe the message shown on the display unit and this may also cause serious security problem which undermines the very purpose of having the safe.

### SUMMARY OF THE PRESENT INVENTION

The invention is advantageous in that it provides an electronic safe comprising a security control system which enables a user to selectively open or close the electronic safe without any interactive signals.

Another advantage of the invention in that it provides an electronic safe comprising a security control system which operates between a normal mode and a security mode, wherein in the normal mode, a user is able to operate the latching device through the control unit which is arranged to generate a predetermined interactive signal in response to the user's control, wherein in the security mode, the user is able to operate the latching device through the control unit which is arranged to not generate interactive signal in response to the user's control.

Another advantage of the invention in that it provides an electronic safe comprising a security control system, wherein the audible sound or interactive signals produced are adjustable to suit users' different needs.

Another advantage of the invention in that it provides an electronic safe comprising a security control system which is compatible to most types of electronic safe. Thus, the instant invention is suitable for widespread application.

Another advantage of the invention in that it provides an electronic safe comprising a security control system which does not alter other aspects of the operation of the safe. In other words, the manufacturing and development cost of the present invention can be kept to the minimum.

Another advantage of the invention in that it provides an electronic safe comprising a security control system which is capable of providing more security options for the user of the present invention. The security control system can be adjusted and programmed to specific users' need.

Additional advantages and features of the invention will become apparent from the description which follows, and may be realized by means of the instrumentalities and combinations particular point out in the appended claims.

According to the present invention, the foregoing and other objects and advantages are attained by providing an electronic safe, comprising:

a security housing having a housing body and a housing door movably connected to the housing body to form a receiving cavity within the security housing;

a latching device provided between the housing body and the housing door for selectively locking the housing door to the housing body; and

a security control system provided on the security housing, and comprises a control provided on the security housing, and is arranged to be operated between a normal mode and a security mode, wherein in the normal mode, a user is able to operate the latching device through the control unit which is arranged to generate a predetermined interactive signal in response to the user's control, wherein in the security mode, the user is able to operate the latching device through the control unit which is arranged to not generate interactive signal in response to the user's control.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of an electronic safe according to a preferred embodiment of the present invention.

FIG. 2 is a block diagram of an electronic safe according to the above preferred embodiment of the present invention.

FIG. 3 is a schematic diagram of an electronic safe according to the above preferred embodiment of the present invention.

FIG. 4 is a schematic diagram of the electronic safe according to the above preferred embodiment of the present invention, illustrating different types of input device of the security control system.

### DETAILED DESCRIPTION OF THE PREFERRED EMBODIMENT

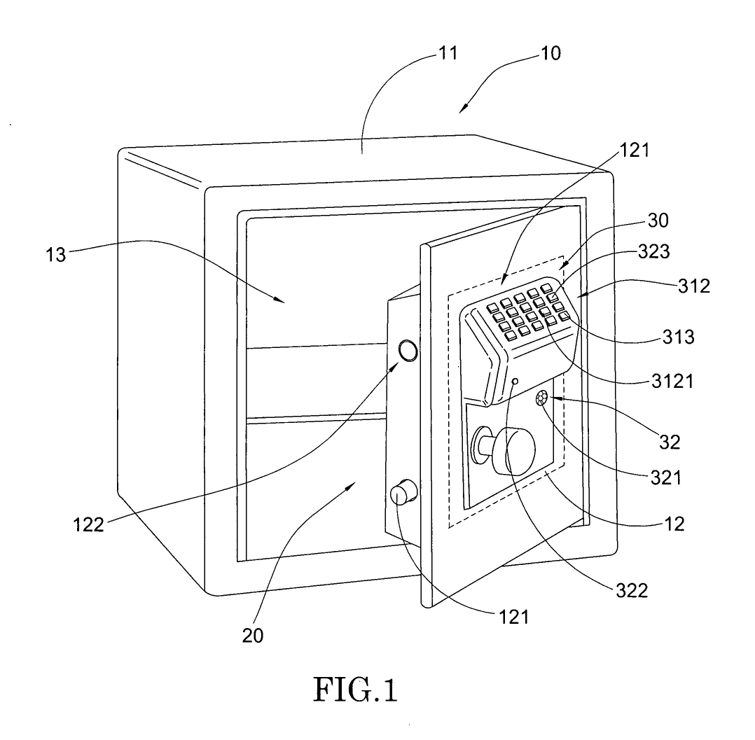

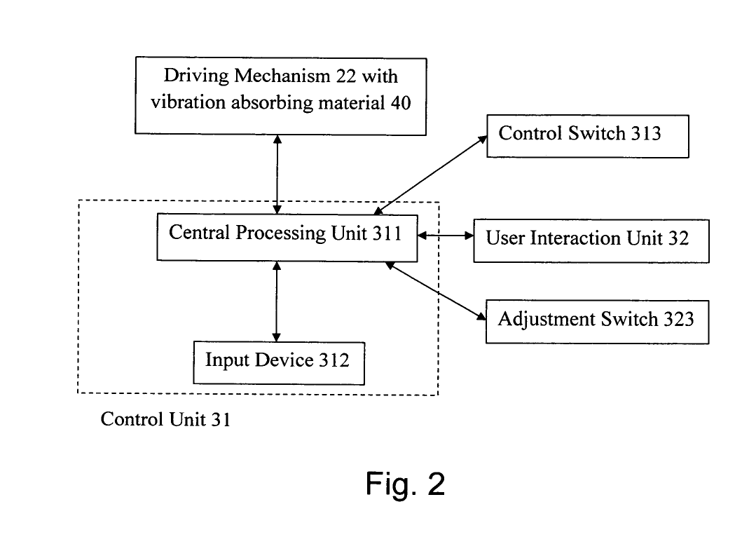

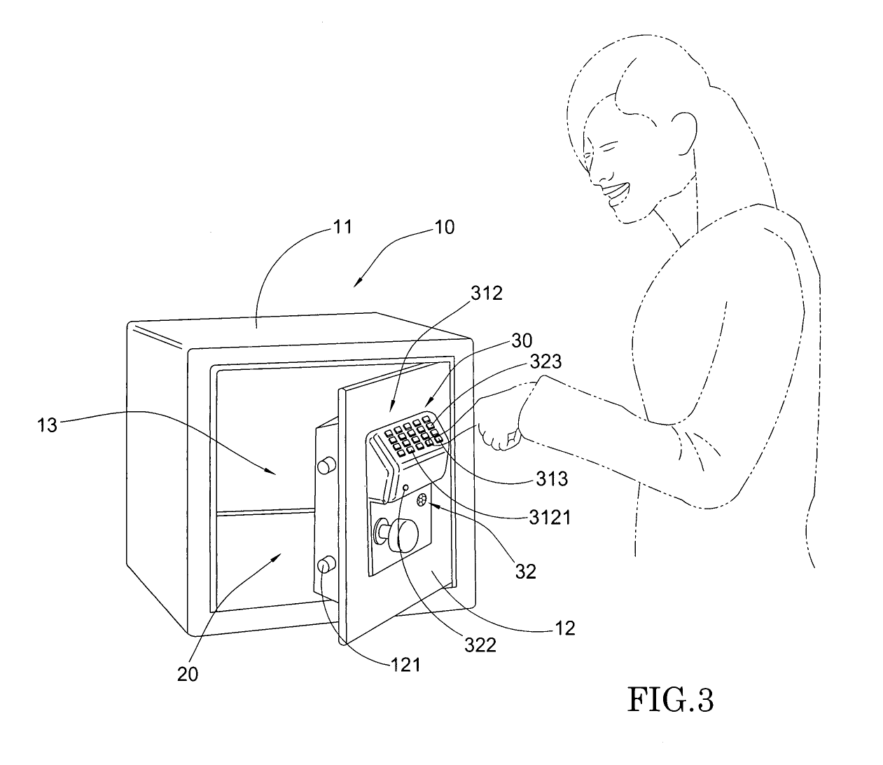

Referring to FIG. 1 to FIG. 3 of the drawings, an electronic safe according to a preferred embodiment of the present invention is illustrated, in which the electronic safe comprises a security housing 10, a latching device 20 and a security control system 30.

The security housing 10 has a housing body 11 and a housing door 12 movably connected to the housing body 11 to form a receiving cavity 13 within the security housing 10. On the other hand, the latching device 20 is provided between the housing body 11 and the housing door 12 for selectively locking the housing door 12 to the housing body 11.

The security control system 30 is provided on the security housing 10, and comprises a control unit 31 provided on the security housing 10, and is arranged to be operated between a normal mode and a security mode, wherein in the normal mode, a user is able to operate the latching device 20 through the control unit 30 which is arranged to generate a predetermined interactive signal in response to the user's control, wherein in the security mode, the user is able to operate the latching device 20 through the control unit 30 which is arranged to not generate any interactive signal in response to the user's control.

According to the preferred embodiment of the present invention, the security housing 10 is preferably made of reinforced and fireproof material so that the objects stored in the receiving cavity 13 is given the maximum protection from external events.

The latching device 20 is primarily used for locking the housing door 12 to the housing body 11. The latching device 20 is received in the housing door 12 and is arranged to be controllably and selectively extended to interlock with the housing body 11. In this preferred embodiment, the latching device 20 is controlled by the security control system 30 in such a manner that a user is able to control locking and unlocking of the latching device 20 through the security control system 30.

Thus, the latching device 20 comprises a plurality of locking latches 21 and a driving mechanism 22 connecting between the locking latches 21 and the security control system 30 such that when the security control system 30 generates a control signal for either locking or unlocking the housing door 12, the driving mechanism 22 is arranged to be driven to control a corresponding movement of the locking latches 21 so as to lock and unlock the housing door 12 respectively. Furthermore, the housing door 12 further has a control cavity 121 formed therein, and a latching slot 122 formed at a side edge portion of the housing door 12 for communicating the control cavity 121 with an exterior of the housing door 12, wherein the latching device 20 is received in the control cavity 121 for controlling an operation of the housing door 12.

The control unit 31 of the security control system 30 comprises a central processing unit 311 received in the housing door 12 and an input device 312 provided on the housing door 12 and is electrically connected to the central processing unit 311, wherein a user is able to control an operation of the latching device 20 through operating on the input device 312. Note that the input device 312 can be embodied as a wide range of input devices for receiving different input commands.

For example, the input device 312 may comprise a keypad 3121 provided on the housing door 12, wherein a user can press on the keypad to input a predetermined password for unlocking the housing door 12. Furthermore, the keypad may comprise a plurality of numerals keys as well as alphabet keys for allowing a user to input specific control commands to be executed by the central processing unit 311.

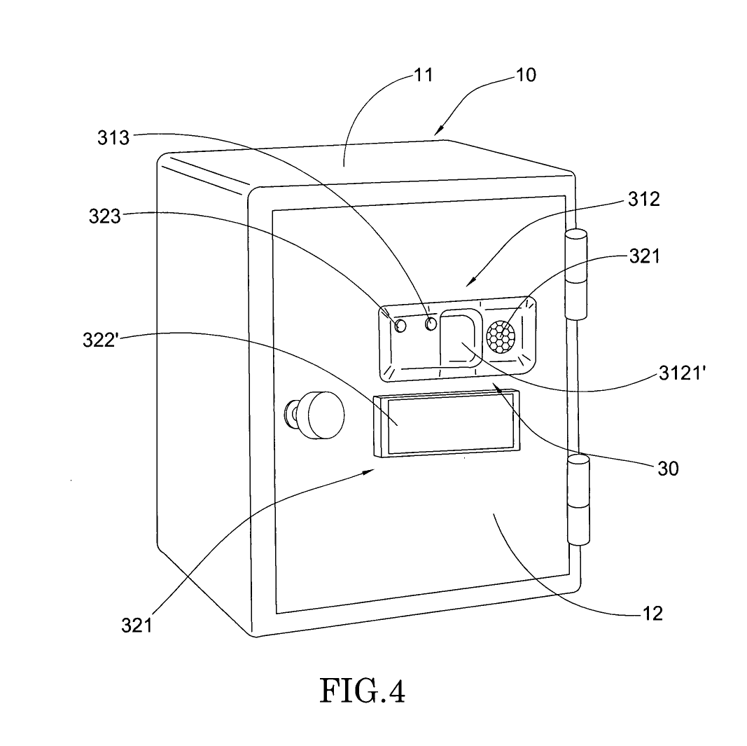

As an alternative as shown in FIG. 4 of the drawings, the input device 312 may comprises a biometrics sensor 3121′ for scanning biometrics features of the person wishing to unlock the electronic safe. The biometrics sensor 3121′ can be embodied as many types of sensors for scanning different biometrical features of the user. For example, the biometrics sensor 3121′ can be embodied as a fingerprint scanning arranged to scan a fingerprint of the person wishing to unlock the housing door 12. Alternatively, the biometrics sensor 3121′ can be embodied as an iris scanner arranged to scan the iris of the person wishing to unlock the housing door 12. All these sensors are intended to make proper identification of the person wishing to unlock the housing door 12.

The security control system 30 further comprises a user interaction unit 32 provided on the security housing 10 for interactively and selectively alerting the user's of the operational status. The user interaction unit 32 comprises an audio unit 321 electrically connected to the central processing unit 311 and are arranged to be driven to generate a predetermined alert signal in response to user's operation. Thus, when the security control system 30 is in the normal mode, the user interaction unit 32 is arranged to generate a predetermined interactive signal for alerting the user of the corresponding operation. In this preferred embodiment, the interactive signal preferably takes the form of an audible sound so that when the user operates on the input device 312, the audio unit 321 is arranged to generate corresponding audible sound (such as “beep” sound) to signal a particular key is pressed or the housing door 12 is being unlocked.

However, when the security control system 30 is in the security mode, the audio unit 321 of the user interaction unit 32 will be disabled so that when the user operates on the input device 312, no audible sound will be generated.

Furthermore, the user interaction unit 32 further comprises a visual display unit 322 provided on the security housing 10 for providing visual signal in response to user's input. Note that the visual display unit 322 may be embodied as a wide variety of devices which are capable of producing a predetermined visual effect to the user in response to user's operation on the input device 312. For example, the visual display unit 322 may comprise at least one LED provided on the security housing 10 (preferably the housing door 12) and is arranged to generate illumination when a predetermined status of the latching device 20 has been reached. For example, the LED is arranged to generate a particular pattern of illumination when the latching device 20 is activated to unlock the housing door 12. Alternatively, the visual display unit 322 may comprise a LCD display provided on the housing door 12 for indicating the locking status thereof.

More importantly, the control unit 31 of the security control system 30 further comprises a control switch 313 provided on the security housing 10 and is electrically connected to the central processing unit 311 for selectively turning on or off the user interaction unit 32 so as to allow the security control system 30 to work under the security mode. In other words, when the control switch 313 is turned on so that the user interaction unit 32 is turned on, the security control system 30 is arranged to work under the normal mode and the user may get feedback or signals (either audio signal, visual signal or both) from the user interaction unit 32. Conversely, when the control switch 313 is turned off, the security control system 30 is arranged to work under the security mode and the user will not receive any feedback signal (audio signal, visual signal or both) from the user interaction unit 32.

The central processing unit 311 of the control unit 31 is embodied as a control circuitry for electrically controlling an operation of the security control system 30 and the latching device 20. The central processing unit 311 is programmable so that user may determine the exact manner in which the electronic safe is to be operated.

It is worth mentioning that the control switch 313 is arranged to selectively and separately control the operation the audio unit 321 and the visual display unit 322 so that the user is able to turn on or turn off either the audio unit 321 or the visual display unit 322, or both, depending on the circumstances in which the electronic safe of the present invention is utilized.

Apart from turning the user interaction unit 32 off out right, the user interaction unit 32 comprises an adjustment switch 323 provided on the security housing 10 and is electrically connected to the central processing unit 311 for allowing the user to adjust a volume of the audible sound coming out from the audio unit 321.

In order to ensure maximum security, central processing unit 311 is programmed to drive the audio unit 321 of the user interaction unit 32 to generate a predetermined amount of warning sound when the housing door 12 is left open for a predetermined period of time. This feature ensures that the user is sufficiently and timely alerted when the housing door 12 is left open for an extended period of time.

It is also important to mention that the user interaction unit 32 can also be programmed in other ways to fit different circumstances of uses. For example, the audio unit 321 can be programmed to allow to work in the security mode only for certain operation or in response to a predetermined actuation. For example, the control switch 313 may work in a way as to allow the user to set the security control system 30 to work in an one-time security mode. The control switch 313 is arranged to provide this feature when the user presses on the control switch 313 for an extended period of time or in a predetermined manner.

The security housing 10 further comprises a predetermined amount of vibration absorbing material 40 attached on the latching device 20 and the housing door 12 for further reducing vibration induced noise from the electronic safe. The vibration absorbing material 40 helps in reducing the noise resulting from operation of the latching device 20. This is especially important when the security control system 30 is in the security mode, because the user of the present invention wants to use the electronic safe in a very silent manner and the vibration absorbing material 40 allows the user to accomplish this objective.

Finally, it is worth mentioning that user interaction unit 32 can only comprise the audio unit 321, the visual display unit 322, or both. The manufacturer of the present invention can equip different electronic safes with different options and devices so as to meet particular marketing or utility needs. In cases where the user interaction unit 32 only comprises the visual display unit 322, the illumination from the LED or display will be turned off when the security control system 30 is in the security mode. In cases where the user interaction unit 32 comprises both the audio unit 321 and the visual display unit 322, the illumination from the LED or display and the audible sound will be turned off when the security control system 30 is in the security mode.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An electronic safe, comprising:
a security housing having a housing body and a housing door movably connected to said housing body to form a receiving cavity within said security housing;
a latching device provided between said housing body and said housing door for selectively locking said housing door to said housing body; and
a security control system provided on said security housing, and comprises a control unit provided on said security housing, and is arranged to be operated between a normal mode and a security mode, wherein in said normal mode, a user is able to operate said latching device through said control unit which is arranged to generate a predetermined interactive signal in response to said user's control, wherein in said security mode, said user is able to operate said latching device through said control unit which is arranged to not generate any interactive signal in response to said user's control.

2. The electronic safe, as recited in claim 1, wherein said control unit of said security control system comprises a programmable central processing unit received in said housing door and an input device provided on said housing door and is electrically connected to said central processing unit, wherein a user is able to control an operation of said latching device through operating on said input device.

3. The electronic safe, as recited in claim 2, wherein said input device comprises a keypad provided on said housing door, wherein a user is able to press on said keypad to input a predetermined password for unlocking said housing door, wherein said keypad comprises a plurality of numerals keys and alphabet keys for allowing a user to input specific control commands to be executed by said central processing unit.

4. The electronic safe, as recited in claim 2, wherein said input device comprises a biometrics sensor for scanning biometrics features of said user wishing to unlock said housing door.

5. The electronic safe, as recited in claim 3, wherein said security control system further comprises a user interaction unit which comprises an audio unit electrically connected to said central processing unit and is arranged to be driven to generate predetermined audible sound in response to user's operation of said electronic safe when said security control system is in said normal mode, wherein when said security control system is in said security mode, said audio unit of said user interaction unit is disabled so that when said user operates on said input device, no audible sound is generated.

6. The electronic safe, as recited in claim 4, wherein said security control system further comprises a user interaction unit which comprises an audio unit electrically connected to said central processing unit and is arranged to be driven to generate predetermined audible sound in response to user's operation of said electronic safe when said security control system is in said normal mode, wherein when said security control system is in said security mode, said audio unit of said user interaction unit is disabled so that when said user operates on said input device, no audible sound is generated.

7. The electronic safe, as recited in claim 3, wherein said security control system further comprises a user interaction unit which comprises a visual display unit provided on said security housing for providing visual signal in response to user's input.

8. The electronic safe, as recited in claim 4, wherein said security control system further comprises a user interaction unit which comprises a visual display unit provided on said security housing for providing visual signal in response to user's input.

9. The electronic safe, as recited in claim 5, wherein said user interaction unit further comprises a visual display unit provided on said security housing for providing visual signal in response to user's input.

10. The electronic safe, as recited in claim 6, wherein said user interaction unit further comprises a visual display unit provided on said security housing for providing visual signal in response to user's input.

11. The electronic safe, as recited in claim 6, wherein said security control system further comprises a control switch provided on said security housing and is electrically connected to said central processing unit for selectively turning on and off said user interaction unit so as to allow said security control system to work between said normal mode and said security mode.

12. The electronic safe, as recited in claim 7, wherein said security control system further comprises a control switch provided on said security housing and is electrically connected to said central processing unit for selectively turning on and off said user interaction unit so as to allow said security control system to work between said normal mode and said security mode.

13. The electronic safe, as recited in claim 8, wherein said security control system further comprises a control switch provided on said security housing and is electrically connected to said central processing unit for selectively turning on and off said user interaction unit so as to allow said security control system to work between said normal mode and said security mode.

14. The electronic safe, as recited in claim 10, wherein said security control system further comprises a control switch provided on said security housing and is electrically connected to said central processing unit for selectively turning on and off said user interaction unit so as to allow said security control system to work between said normal mode and said security mode.

15. The electronic safe, as recited in claim 13, wherein said user interaction unit comprises an adjustment switch provided on said security housing and is electrically connected to said central processing unit for allowing said user to adjust a volume of said audible sound coming out from said audio unit.

16. The electronic safe, as recited in claim 14, wherein said user interaction unit comprises an adjustment switch provided on said security housing and is electrically connected to said central processing unit for allowing said user to adjust a volume of said audible sound coming out from said audio unit.

17. The electronic safe, as recited in claim 15, wherein said audio unit of said central processing unit is preprogrammed to drive said user interaction unit to generate a predetermined amount of warning sound through said audio unit when said housing door is left open for a predetermined period of time.

18. The electronic safe, as recited in claim 16, wherein said audio unit of said central processing unit is preprogrammed to drive said user interaction unit to generate a predetermined amount of warning sound through said audio unit when said housing door is left open for a predetermined period of time.

19. The electronic safe, as recited in claim 12, wherein said security housing further comprises a predetermined amount of vibration absorbing material attached on said latching device and said housing door for further reducing vibration induced noise from said electronic safe.

20. The electronic safe, as recited in claim 13, wherein said security housing further comprises a predetermined amount of vibration absorbing material attached on said latching device and said housing door for further reducing vibration induced noise from said electronic safe.

21. The electronic safe, as recited in claim 17, wherein said security housing further comprises a predetermined amount of vibration absorbing material attached on said latching device and said housing door for further reducing vibration induced noise from said electronic safe.

22. The electronic safe, as recited in claim 18, wherein said security housing further comprises a predetermined amount of vibration absorbing material attached on said latching device and said housing door for further reducing vibration induced noise from said electronic safe.
